(19) United States
(12) Patent Application Publication
(10) Pub. No.: US 2006/0282321 A1
(43) Pub. Date: Dec. 14, 2006

(54) METHOD AND SYSTEM FOR BULK SOIL MARKETING, ORDER ENTRY AND DELIVERY

(75) Inventors: Steve Schiedel, Mount Hope (CA); Brian Muegge, Hamilton (CA); Peter Rauwerda, Caledonia (CA)

Correspondence Address: LANG MICHENER LLP, BCE PLACE, SUITE 2500, 181 BAY STREET, TORONTO, ON, M5J 2T7, CA

(73) Assignee: GREENHORIZONS GROUP OF FARMS LTD., Mount Hope (CA)

(21) Appl. No.: 11/419,326

(22) Filed: May 19, 2006

Related U.S. Application Data
(60) Provisional application No. 60/682,389, filed on May 19, 2005.

(51) Int. Cl. G07G 1/14; G06Q 30/00

(52) U.S. Cl. 705/14; 705/26

(57) ABSTRACT

In a method of bulk soil order entry, delivery and marketing, an order for bulk soil bags is received and recorded, along with a delivery address. Each bag has a re-closable top portion, and an outer surface having promotional indicia thereon. The bags are loaded onto a truck bed and transported to the delivery address. A system for delivering bulk soil also includes a forklift that is mounted on the truck during transport. The forklift is removable therefrom at the delivery address and has forklift tines that lift the bags from the truck bed by their carry straps. At the delivery address, the bags are thereafter precisely placed at a customer-specified location. Each bag is positioned with its promotional indicia outwardly displayed, in substantially unobstructed relation, from the truck bed and/or the customer-specified location.

The present invention relates to the field of soil delivery methods, and more particularly, to a method and system for bulk soil marketing, order entry and delivery.

### BACKGROUND OF THE INVENTION

Every spring, thousands of homeowners and amateur and professional horticulturalists and agriculturalists are faced with the problem of how to get large quantities of rich planting soil into their gardens and yards. In the past, such persons have had to choose between having a bulk load of soil loosely dumped on their driveway (or elsewhere on their property that lay substantially adjacent to road access), or buying a large number of small individual bags, each sized to accommodate a mere one cubic foot of soil—an agriculturally (and horticulturally) ineffective quantity of soil.

There are a number of problems associated with the dumping of bulk soil onto a driveway and/or near a road access, not least of which is that such soil is often delivered right in the middle of the rainy season, such that a portion of the soil washes away, leaving an unsightly mess that is more mud than soil. In the alternative, quite apart from any added cost consequences, soil purchasers that have heretofore decided to buy their soil in a plurality of individual bags have typically been faced with the inconvenience of having to lift and transport the soil themselves, or otherwise make their own arrangements for its delivery (i.e., independent of their purchase agreement with the soil vendors).

In the prior art, there have also been attempts to use a truck-mounted cranes to deliver bulk soil, but such systems have not allowed for precise placement of soil in a wide enough range of locations to suit the needs of consumers. What is needed, therefore, is a system, method, or apparatus that might enable a bulk soil vendor to deliver and precisely place an agriculturally (or horticulturally) useful quantity of bulk soil in accordance with the needs and/or preferences of consumers.

Now, while the prior art may disclose truck mountable forklifts, such equipment is typically extremely expensive. Were it not for the great expense associated with purchasing and maintaining same, persons of ordinary skill in the art might otherwise have contemplated the potential uses of such equipment in the delivery of bulk soil. It should be appreciated, as well, that the prior art does not disclose any apparatus, system, or method to offset, reduce, or mitigate the high monetary cost which is naturally associated with such equipment. Accordingly, any uses of truck mountable forklifts in the delivery of bulk soil have heretofore been viewed as highly impractical and cost prohibitive.

As such, the prior art has thus far failed to provide a cost effective and commercially viable system for delivering soil to end consumers that adequately addresses each of the aforementioned problems.

It is thus an object of the invention to, among other things, obviate or mitigate one or more of the above-mentioned disadvantages, shortcomings, and/or problems associated with the prior art.

### SUMMARY OF THE INVENTION

In accordance with the present invention there is disclosed a method of bulk soil order entry, delivery and marketing. The method includes a first step of receiving and electronically recording an order for delivery of one or more substantially agriculturally effective quantities of bulk soil. In the first step, a delivery address is electronically recorded for each aforesaid order, with the delivery address being in a geographic neighborhood. In a second step, the quantities of bulk soil are mechanically loaded into one or more bags, with each of the bags having a flexible bag body that contains one of the quantities of bulk soil. The bag body defines a selectively closable bag aperture substantially adjacent to a top portion thereof. The bag body includes an outer surface that has one or more promotional indicia marked thereon. In a third step, the bags are mechanically loaded onto a truck bed of a truck. In a fourth step, the truck is transported substantially to the delivery address. In a fifth step, the bags are mechanically removed from the truck bed, and precisely placed substantially at a customer-specified location at the delivery address. According to the method, each of the bags is positioned such that the promotional indicia are outwardly displayed, in substantially unobstructed relation, from at least one of the truck bed and the customer-specified location.

According to one embodiment of the invention, the method may preferably, but need not necessarily, include a sixth step of electronically generating target addresses from a database that includes prospective customer addresses. Each of the target addresses is substantially within the geographic neighborhood of the delivery address. According to this embodiment of the invention, the method may also preferably, but need not necessarily, include a seventh step of marking the target addresses one each on promotional circulars, so as to provide for subsequent distribution of the promotional circulars to the target addresses.

According to one embodiment of the invention, the target addresses may preferably, but need not necessarily, include substantially all of the prospective customer addresses within at least one zoned postal area. According to one embodiment of the invention, the zoned postal area may preferably, but need not necessarily, define a region that is selected from the group consisting of a zip code area and a postal code area.

According to one embodiment of the invention, the promotional circulars may preferably, but need not necessarily, display one or more order incentives that are redeemable prior to an incentive expiry date.

According to one embodiment of the invention, the method may preferably, but need not necessarily, include a step, before the first step, of pre-scheduling the truck to make bulk soil deliveries in the geographic neighborhood on one or more delivery dates. According to this embodiment of the invention, the method may preferably, but need not necessarily, further include a step, before the second step, of electronically generating a prompt for customer selection of one of the delivery dates for the order.

According to one embodiment of the invention, the method may preferably, but need not necessarily, include a still further step, before the second step, of electronically confirming, by comparison of the quantities with substantially current availability data for the truck and the bulk soil that the quantities of bulk soil are available to be delivered within the geographic neighbourhood on the aforesaid one of the delivery dates.

According to one embodiment of the invention, the method may preferably, but need not necessarily, include a yet still further step, before the second step in the event that the quantities are not available to be delivered within the geographic area on, the aforesaid one of the delivery dates, of electronically generating a second prompt for customer selection of another of the delivery dates for the order.

According to one embodiment of the invention, the method may preferably, but need not necessarily, include first and second substeps, before the fourth step, of grouping together each aforesaid delivery address within the geographic neighborhood, and sequencing in a substantially efficient delivery route each aforesaid delivery address that is to be visited by the truck on the aforesaid one of the delivery dates. According to this embodiment of the invention, the method may preferably, but need not necessarily, include a third substep, before the fourth step, of generating for sequential display within the truck one or more individual maps. Each one of the individual maps preferably depicts one aforesaid delivery address.

According to one embodiment of the invention, the method may preferably, but need note necessarily, include a step, before the fourth step, of electronically generating a reminder to have the customer-specified location physically marked at the delivery address.

According to one embodiment of the invention, each of the promotional circulars and the reminder may preferably, but need not necessarily, be sent to the delivery address by at least one delivery methodology that is selected from the group consisting of mail delivery, facsimile delivery, courier delivery, delivery via the internet, and aural delivery via the telephone.

According to one embodiment of the invention, each of the bags may preferably, but need not necessarily, be provided with one or more carry straps extending from the bag body. The carry straps are preferably adapted to provide for substantially secure suspension therefrom of the bag body containing the aforesaid one of the quantities of bulk soil. According to this embodiment of the invention, the method may preferably, but need not necessarily, include a step, before the fourth step, of mounting a forklift on the truck. The method may also preferably, but need not necessarily, include a further step, after the fourth step, of dismounting the forklift from the truck. According to this embodiment of the invention, in the fifth step, the forklift lifts each of the bags from the truck bed by the carry straps, and precisely places the bags substantially at the customer-specified location.

According to one embodiment of the invention, the method may preferably, but need riot necessarily, include another step, before completion of the first step, of electronically entering at least two approximate dimensions of a space for desired application of the bulk soil. According to this embodiment of the invention, the method may preferably, but need not necessarily, include vet another step, before completion of the first step, of electronically calculating, using the aforesaid dimensions, a minimum number of the aforesaid bags which will be required for the desired application.

In accordance with the present invention there is also disclosed a system for use in delivering bulk soil to a customer-specified location at a delivery address. The system includes a plurality of bags, each having a flexible bag body that contains a substantially agriculturally effective quantity of bulk soil. The bag body defines a selectively closable bag aperture substantially adjacent to a top portion thereof. The bag body includes an outer surface that has one or more promotional indicia marked thereon. Each of the bags also has one or more carry straps extending from the bag body, with the carry straps adapted to provide for substantially secure suspension therefrom of the bag body containing the aforesaid quantity of bulk soil. The system further includes a truck having a truck bed. The plurality of bass are supported on the truck bed. The truck is mobile to provide for transport to the delivery address. The system also includes a forklift mounted on the truck during the aforesaid transport to the delivery address. The forklift is removable from the truck into a dismounted configuration at the delivery address. The forklift has forklift tines that are adapted to operatively lift at least one of the bags from the truck bed by the carry straps. The forklift is substantially mobile in the dismounted configuration to provide for precise placement of the aforesaid at least one of the bags substantially at the customer-specified location. According to the system, each of the bags is positioned such that the promotional indicia are outwardly displayed, in substantially unobstructed relation, from at least one of the truck bed and the customer-specified location.

According to one embodiment of the invention, the system may preferably, but need not necessarily, include an order entry subsystem that electronically receives and records an order for delivery of the aforesaid at least one of the bags, along with the delivery address.

According to one embodiment of the invention, the order entry subsystem may preferably, but need not necessarily, electronically generate one or more sets of delivery instructions for display within the truck.

According to one embodiment of the invention, the order entry subsystem may preferably, but need not necessarily, electronically generate a reminder to have the customer-specified location marked with an identifying indicia before the aforesaid transport to the delivery address.

According to one embodiment of the invention, the order entry subsystem may preferably, but need not necessarily, record the customer-specified location.

According to one embodiment of the invention, the bag body may preferably, but need not necessarily, be adapted to substantially protect the aforesaid quantity of bulk soil from external environmental conditions.

According to one embodiment of the invention, the bag body may preferably, but need not necessarily, include a cinchable strap means, substantially encircling the top portion of the bag body, for selectively closing the bag aperture.

In accordance with the present invention, the bulk soil bag is sized to accommodate a significant quantity of soil and is re-closable, preferably, but not necessarily, so as to protect contained soil from the elements. Among other things, the system and method may preferably, but need not necessarily: (a) market bulk soil to a small geographic area using targeted media; (b) offer incentives and discounts for early orders and deliveries; (c) generate and, send marketing materials to all homeowners within a particular range of postal or zip codes; (d) generate and send marketing materials to existing retail sod customers, previous soil purchasers, and/or the neighbors of previous soil purchasers; (e) require a customer to select a preferred delivery date from a limited list of dates on which deliveries will be made elsewhere in that delivery zone or geographic region; (f) electronically calculate the required amount of soil or sod on the basis of the size and configuration of the space to be covered; (g) assess whether a particular order exceeds the maximum deliverable amount or soil or sod in a particular zone or division or on a first preferred delivery date, and in such, event may preferably, but need not necessarily, require the customer to select a second preferred delivery date from a newly generated list; (h) instruct a customer to physically mark a desired specific delivery location on their driveway, or in another desired location where the soil or sod is to be delivered; (i) print a map and invoice corresponding to each order and delivery address for a particular delivery date; (j) mark all of the delivery addresses for the delivery date on a single map; (k) group the delivery addresses for the delivery date according to truck so as to provide an efficient delivery route; (l) sequentially arrange the delivery addresses for each truck in an order that corresponds to an efficient delivery route; (m) clearly display the promotional indicia from the bulk soil bag, so as to be visible to neighboring homeowners and passersby; (n) need not require a customer or homeowner to be home when the delivery occurs, (o) offers a monetary incentive to a homeowner or customer for returning a bulk soil bag after it has been emptied; (p) calculates the number of bulk soil bags delivered on the delivery date by each driver; and/or (q) offers a monetary incentive to a driver for reaching certain predetermined daily delivery targets.

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the method and system for bulk soil marketing, order entry, and delivery according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 depicts a system for use in delivering bulk soil according to the invention;

FIG. 2 depicts a forklift of the system of FIG. 1 at a delivery address;

FIG. 3 depicts a bulk soil bag of the system of FIG. 2 at a customer-specified location;

FIG. 4 depicts, in a diagrammatic flowchart, a method of bulk soil marketing, order entry and delivery according to a first preferred embodiment of the invention; and

FIGS. 5A to 5D together depict, in a diagrammatic flowchart, a method of bulk soil marketing, order entry and delivery according to a second preferred embodiment of the invention.

### DETAILED DESCRIPTION OF A PREFERRED EMBODIMENT

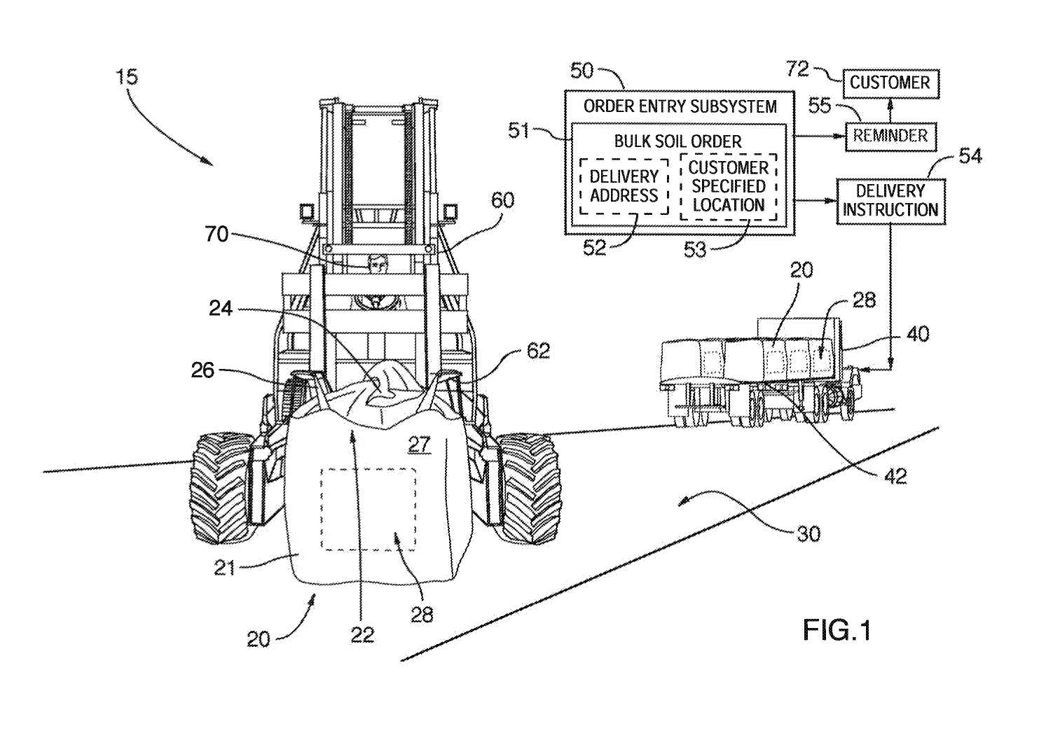

Referring now to FIGS. 1 to 3 of the drawings, there is shown a system 15 according to the invention. As shown in FIG. 1, the system 15 preferably includes an order entry subsystem 50 that records bulk soil orders 51. Each bulk soil order 51 includes a delivery address datum 52, and possibly a customer-specified location datum 53. The order entry subsystem 50 may preferably electronically generate one or more delivery instructions 54 for display within a truck 40 that also forms part of the system. The delivery instructions 54 may include routing directions based on the delivery address datum 52 and/or instructions based on the customer specified location datum 53, among other things. The order entry subsystem 50 may also preferably electronically generate a reminder 55 to have a customer 72 pre-mark a customer-specified location 82 in advance of arrival by the truck 40 at a delivery address 80.

As shown in FIG. 1, a plurality of bulk soil bags 20 are situated for transport over roadways 30 on a flat-bed portion 42 (alternately herein referred to as a truck bed) of the truck 40. A driver 70 is shown driving a truck-mountable forklift 60 that carries one of the bulk soil bags 20 and has been dismounted from the truck 40.

Each of the bulk soil bags 20 is preferably provided with a bag body 21 having a top portion 22. The bag body 21 is sized, dimensioned and otherwise adapted to contain an agriculturally (and horticulturally) effective quantity of soil—i.e., preferably in the approximate range of between about cubic yard and about 1 cubic meter of bulk soil. The top portion 22 of the bag body 21 defines an aperture that is selectively closable by way of a cinchable strap means 24 (alternately herein referred to as a duffel top closure 24). The duffel top closure 24 is substantially adjacent to a top portion 22 thereof, so as to protect contained soil (not shown.) from the elements and other external environmental conditions 10.

The forklift 60 has forklift tines (alternately herein referred to simply as forks 62) which carry the bulk soil bag 20 by sturdy carry straps 26 (also called lifting straps 26) which preferably extend from the bag body 21 substantially adjacent to the top portion 22 thereof.

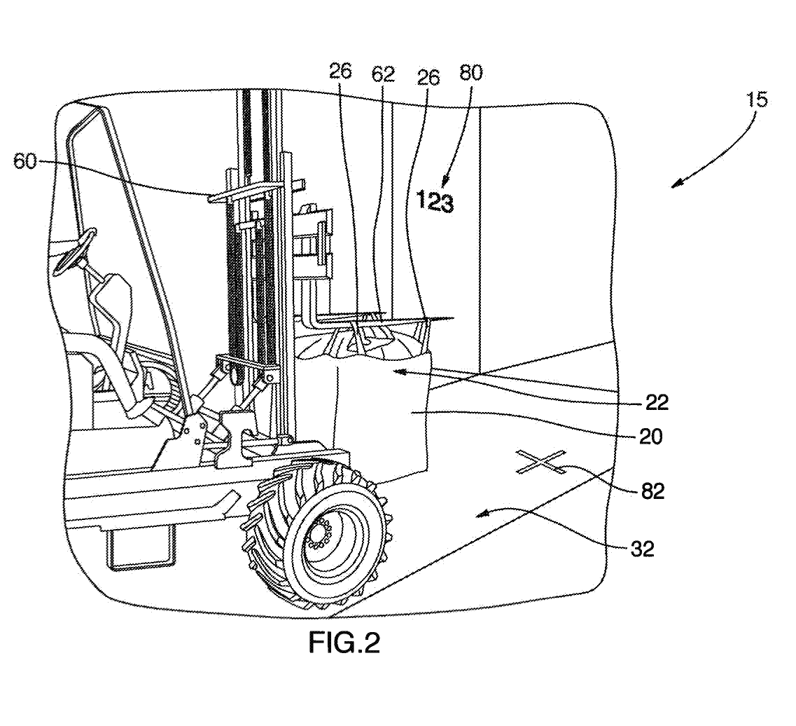

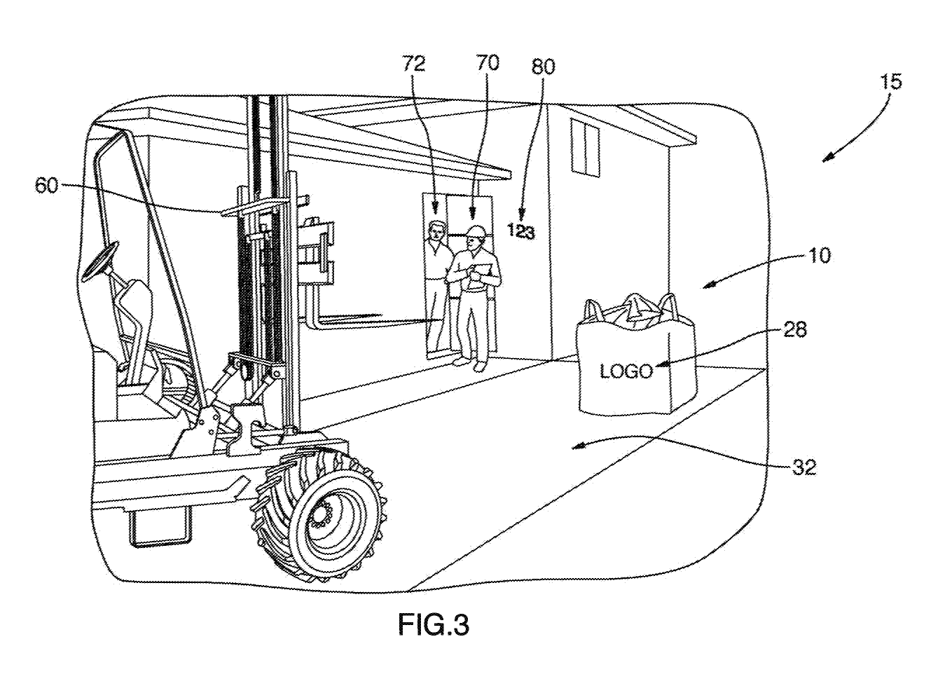

As shown in FIG. 2, the forklift 60 proceeds to the precise delivery location 82 (alternately herein referred to as the customer-specified location 82) which may preferably have been previously marked with an “X” or other identifying indicia by the customer 72 (best seen in FIG. 3) at the delivery address 80. In FIGS. 2 and 3, the delivery location 82 is shown as being situated on a driveway 32, but it might alternately be located elsewhere. Indeed, the use of the forklift 60, with its preferably substantial mobility over both paved surfaces (,e.g., roadways 30 and driveways 32) and unpaved surfaces (e.g., yards and gardens), allows a driver 70 to place the bag 20 in a wide variety of locations. As best seen in FIG. 3, each bag body 20 includes an outer surface 27 that has one or more promotional indicia 28 marked thereon. The promotional indicia 28 may include a logo, a business name, a telephone number, and/or an internet address, among other things. The promotional indicia 28 is adapted to be displayed outwardly, in substantially unobstructed relation (i.e., in a substantially clear line of sight), from the bag 20 towards the neighbors and others in the neighborhood of, and/or on the delivery route to; the delivery address 80 (as best seen in FIGS. 1 and 3).

Methods 100, 200 for bulk soil order entry, delivery, and marketing according to the present invention will now be briefly described with reference to the figures. It will be appreciated by one skilled in the art that the methods 100, 200 which are outlined hereinbelow are but two such methods that fall within the scope of the invention as circumscribed by the appended claims. Indeed, the methods 100, 200 which are discussed hereinbelow are described with reference to the system 15 (which is discussed hereinabove), but such need not have been, the case, and the methods 100, 200 might instead have been described independently thereof. In the following description, the same reference numerals have been used to indicate various components, surfaces, materials, relations, directions, and configurations which are common to both the methods and the system 15 (described above) of the present invention. Notwithstanding any of the above, however, it should be appreciated that, although some of the components, surfaces, materials, relations, directions, and configurations of the system 15 may not be specifically referenced in the following description of the methods 100, 200, they may be used, and/or adapted for use, in association therewith. Similarly, a reference hereinbelow to the system 15 should be taken to have potentially equal application to the methods 100, 200, and vice versa. Indeed, and to a lesser or greater extent, the methods 100, 200 may be hereinafter interchangeably referred to as systems 100, 200.

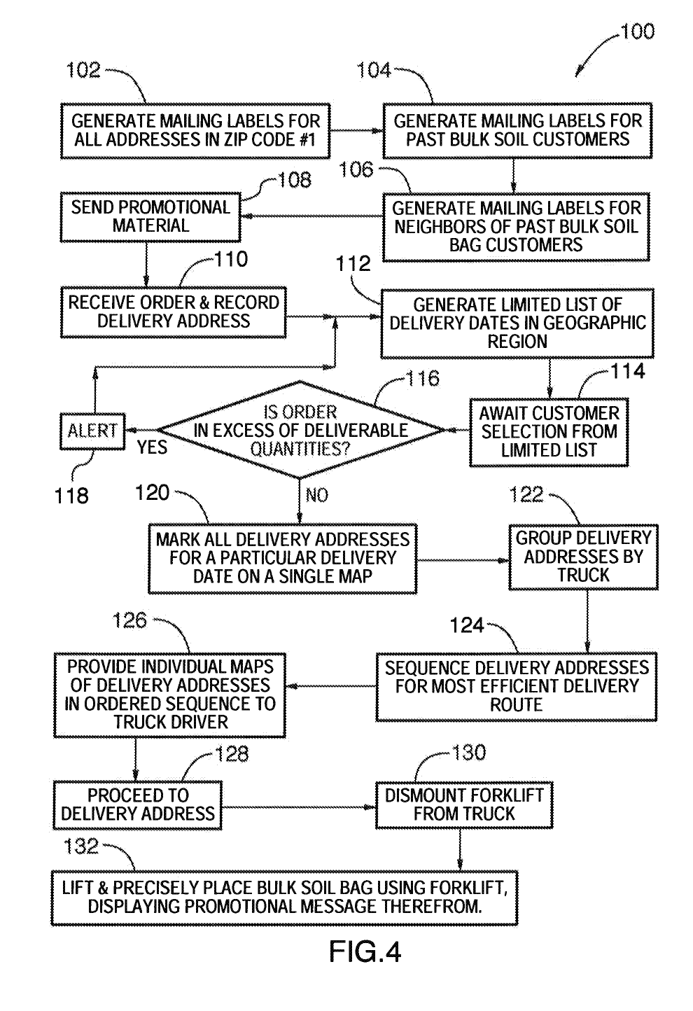

As shown in FIG. 4, and in order to improve efficiency and profitability among other things a firsts preferred embodiment of a method 100 according the invention preferably includes a number of further features over the system 15 which is described hereinabove. According to the method 100, the soil is marketed to a small geographic area using targeted media. In targeting prospective customers, preferably well in advance of an upcoming soil delivery season, the method 100 generates mailing labels, with each of the mailing labels preferably bearing the names, as well as the addresses 80, of prospective customers. Such prospective customers might include previous purchasers of bulk soil bags (in step 104), as well as the neighbors of people who previously purchased bulk bags (in step 106). Additionally, mailing labels may preferably be generated which bear the names and addresses 80 of all homeowners within a particular range of postal or zip codes (in step 102). Following their generation, the mailing labels are affixed to promotional materials (alternately herein referred to as promotional circulars) and, in step 108, the promotional materials are sent out to the prospective customers, either by mail or by another delivery method.

Next, when a prospective customer indicates an interest in having a bulk soil bag 20 delivered, either by telephone, facsimile, over the telephone, internet or otherwise, the order entry phase commences. In step 110 of the method 100, the customer's preferred delivery address 80 is recorded, and in step 112, a limited list of dates on which deliveries will be made in that geographic region is generated. In steep 114 of the method 100, the system 15 may await buyer selection of a preferred delivery date from the limited list of delivery dates in step 116, the method 100 queries whether the soil order is in excess of deliverable quantities, either for the selected delivery date or within the geographic region (as may be based upon soil and/or truck availability, among other things). If the query result from step 116 is “NO”, then the order is entered and the system 100 proceeds to the next phase, as further described hereinbelow. If, however, the query result from step 116 is “YES”, then the system 100 proceeds to step 118 and alerts the soil salesperson (alternately hereinafter referred to as the order entry attendant) that the soil order is in excess of the maximum number of bulk bags 20 which are available for delivery from particular soil processing facility and/or on the selected delivery date. From step 118 of the method 100, the system 15 returns to step 112 and generates a new list of available delivery dates.

In the next phase of the method 100, in step 120, all of the delivery addresses 80 for a particular one of the delivery dates are marked on a single map. Thereafter, in step 122, the delivery addresses 80 on the delivery date are grouped according to the truck 40 responsible for making the deliveries. In step 124, the delivery addresses 80 are put in an ordered sequence corresponding to a substantially efficient delivery route, and preferably corresponding to the most efficient delivery route. In step 126, a map is printed for each individual delivery address 80S and the maps, together with their accompanying invoices, are provided to the driver 70 of the delivery truck 40.

In step 128, the driver 70 of she delivery truck 40 carrying the bulk soil bags 20 (possibly also with skids of sod) proceeds to the first delivery address 80, and dismounts the forklift 60 from the truck 40 (in step 130). Thereafter, in, step 132, the driver 70 uses the forklift 60 to lift one or more of the bulk soil bags 20 from the truck 40, and to precisely place same directly on top of, or substantially adjacent to, the delivery location 82 marked by the customer 72, with the promotional indicia 28 being clearly displayed therefrom, so as to visible to neighboring homeowners, etc.

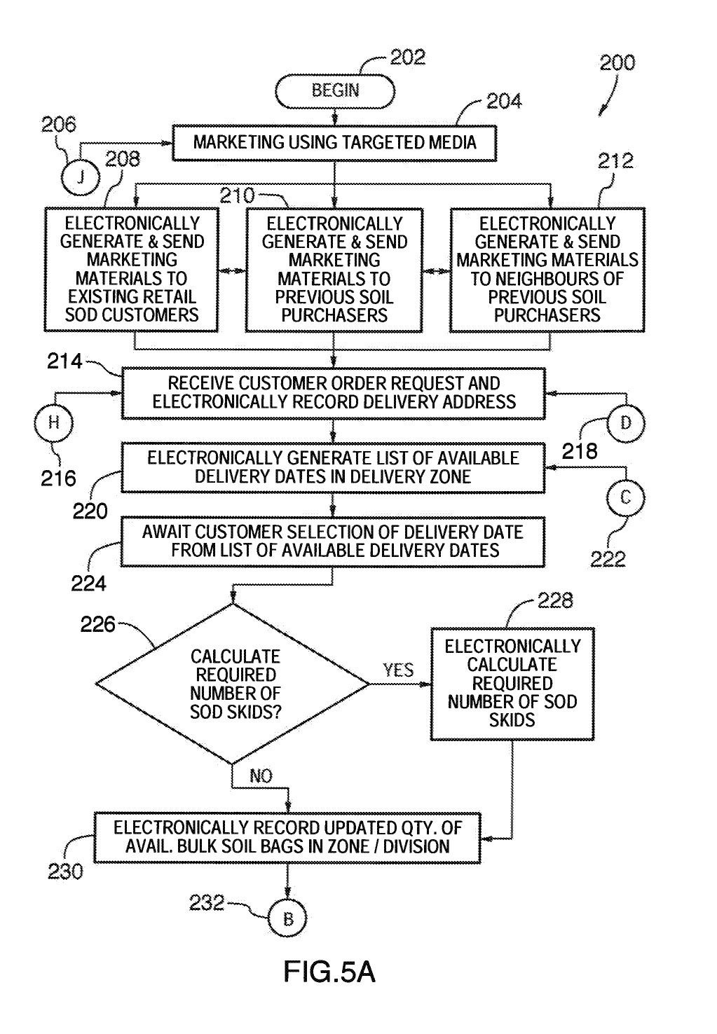

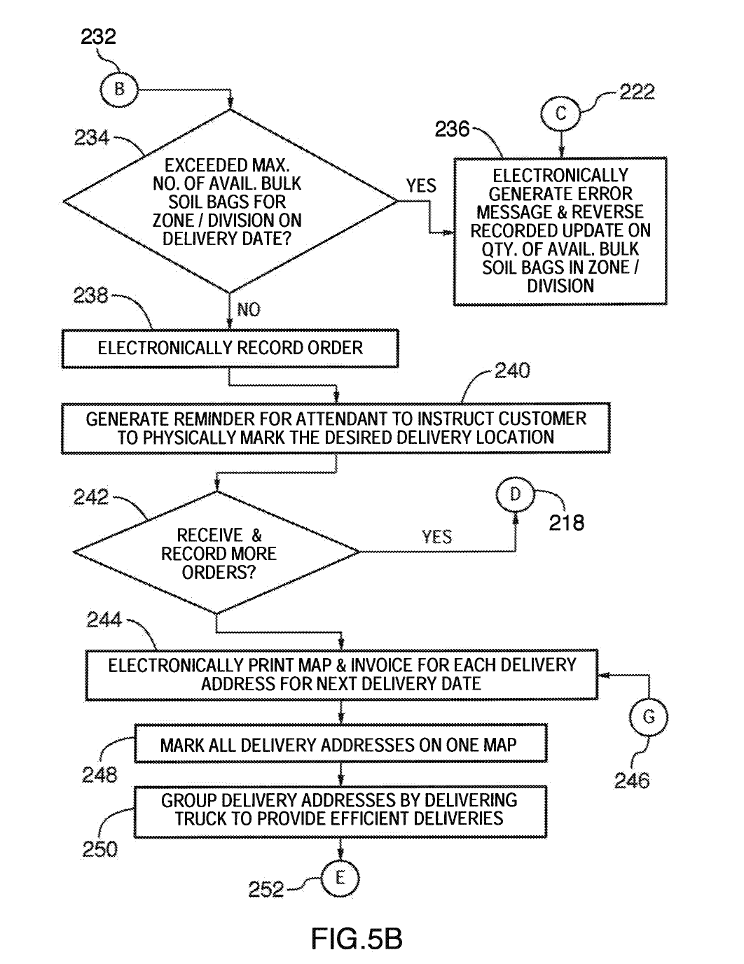

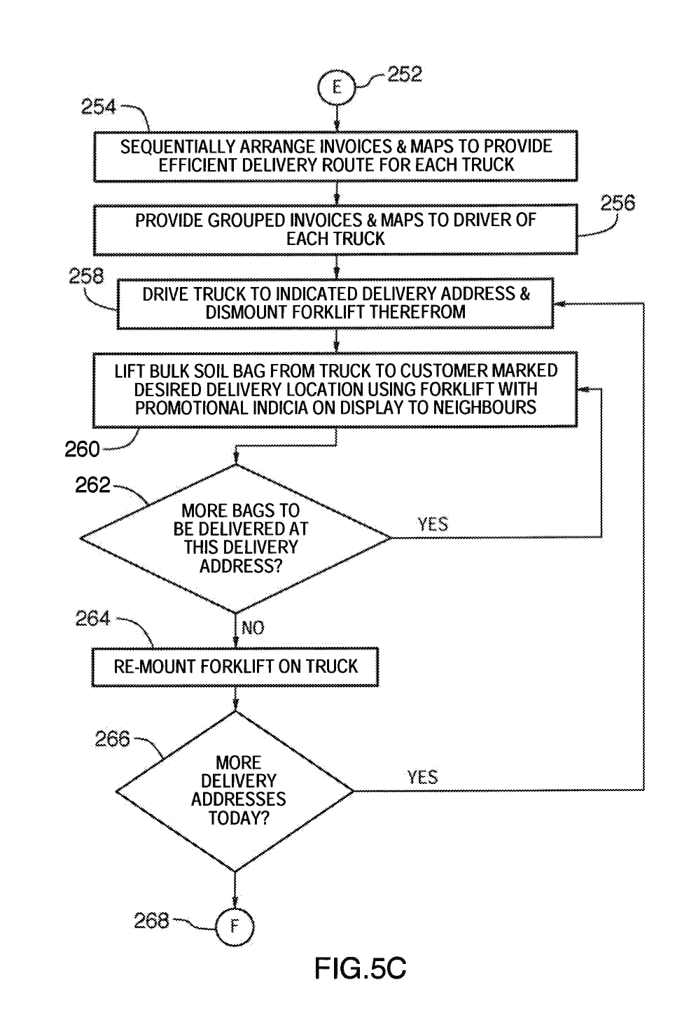

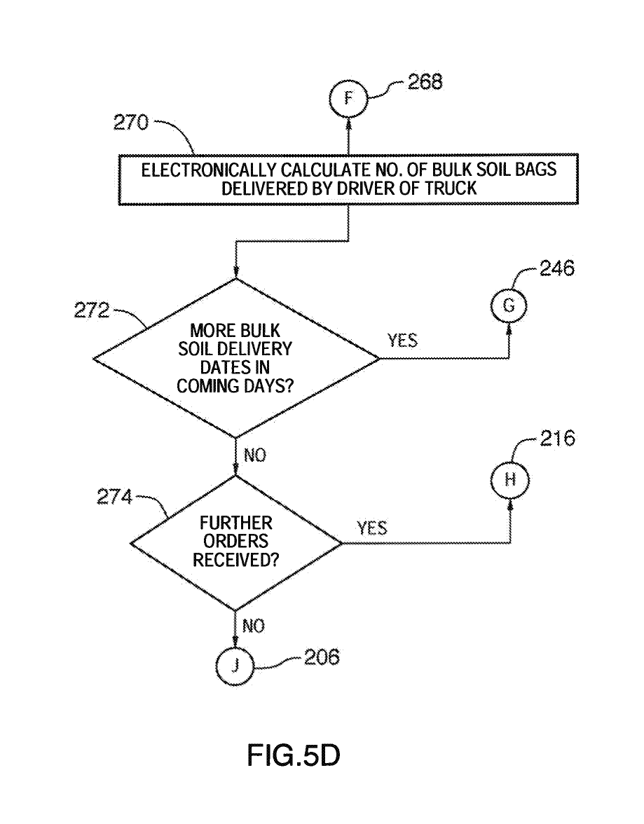

A diagrammatic flowchart of a second preferred embodiment of a method 200 according to the invention is shown in FIGS. 5A to 5D. It will be appreciated that each of FIGS. 5A through 5D leads into at least a respective one other one of FIGS. 5A through 5D, through one or more of encapsulated areas “A” through “J”. It will be appreciated that FIGS. 5A to 5D may hereinafter be collectively referred to as “FIG. 5”. Now, therefore, the method 200 depicted in FIG. 5 includes a number of further and/or alternate features in comparison to those which are discussed hereinabove as being present in the first preferred embodiment of the method 100. According to the second preferred method 200, as with the first preferred method 100, the soil is marketed to a small geographic area using targeted, media (as generally indicated by step 204 in FIG. 5A), with incentives and discounts being offered for early orders and delivery. In targeting prospective customers according to the method 200, the system 15 electronically generates and sends marketing materials (i) to existing retail sod customers in step 208, (ii) to previous soil purchaser in step 210, and/or (iii) to the neighbors of previous soil purchasers in step 212.

Next, in the order entry phase of the method 200, a customer order request is received and the delivery address 80 is electronically recorded in step 214. Thereafter, in step 220 of the method 200, the system 15 generates a limited list of dates on which deliveries will be made elsewhere in that delivery zone or geographic region. In step 224, the customer 72 then selects a preferred delivery date from the limited list of delivery dates.

In the event that the customer 72 has also ordered sod, the system 15 may preferably also query whether it is necessary to calculate the required number of sod skids in step 226. If the query result from step 226 of the method 200 is “YES”, then the system 15 proceeds to step 228 wherein it electronically calculates the required number of skids of sod on the basis of the size and configuration of the space to be covered. It is noted that the method 200 might likewise be adapted to calculate the amount of bulk soil that the customer requires on a similar basis. Following calculation of the amount of an agricultural product (i.e., sod, soil, etc.) that will be required, the system 15 proceeds to step 230 of the method 200.

If the query result from step 226 of the method is “NO”, then the system 15 proceeds to step 230 directly. In step 230 of the method 200, the system 15 records an updated quantity of bulk soil (and/or sod, if desired) which remains available in the zone or division. From there, the system 15 proceeds, through the placeholder step 232, to step 234 which is represented in FIG. 5B. In step 234, the system 200 queries whether the order has exceeded the maximum number of available bulk soil bags for the particular zone or division on the selected delivery date. If the query result from step 234 of the method 200 is “YES”, then the system 15 proceeds to step 236 and electronically generates an error message and reverses the previously recorded (in step 230) update on the quantity of available agricultural product in the zone or division. From step 236 of the method 200, the system proceeds, through the placeholder step 222, to return to step 220 which is represented in FIG. 5A and generates a new list of available delivery dates.

If the query result from step 234 of the method 200 is “NO”, then the system 15 proceeds directly to step 238, wherein the order is electronically recorded in the order entry subsystem 50. Thereafter, in step 240 of the method 200, the system 15 generates a reminder for the order entry attendants to instruct the customer 72 to physically mark the desired specific delivery location 82 on their driveway 32, or in another desired location where the soil is to be delivered (preferably, by marking an “X” in the desired location). The system 15 then queries, in step, 242 of the method 200, whether there are more orders to be received and recorded. If the query result from step 242 is “NO”, then the system 15 proceeds directly to the next phase in step 244 of the method 200. Ifs however, the query result from step 242 is “YES”, then the system 15 proceeds, through the placeholder step 218, to return to step 214 which is represented in FIG. 5A.

In the next phase of the method 200, in step 244, a map and invoice corresponding to each order and delivery address 80 is electronically printed for a particular delivery date. According to the method 200, in step 248, all of the delivery addresses 80 for the delivery date are also marked on a single map. In step 250, the delivery addresses 80 for the delivery date are then grouped according to truck 40 to provide a substantially efficient delivery route. From there, the method 200 proceeds, through the placeholder step 252, to step 254 which is represented in FIG. 50. In step 254, the invoices and maps are sequentially arranged in an order corresponding to the substantially efficient delivery route for each truck 40, and this ordered sequence of invoices and maps is then provided to the driver 70 of each truck 40 (in step 256).

In step 258, the driver 70 of the delivery truck 40 carrying the bulk soil bags 20 and/or skids of sod then proceeds to the first delivery address 80 and dismounts the forklift 60 from the truck 40. Thereafter, in step 260, the driver 70 uses the forklift 60 to lift the bulk soil bag 20 from the truck 40, and to precisely place same directly on top of, or substantially adjacent to, the delivery location 82 that the customer 72 was previously instructed to mark (in step 240), with the promotional indicia 28 being clearly displayed therefrom, so as to visible to neighboring homeowners, etc. In step 262 of the method 200, the driver 70 then queries whether there are more bags 20 to be delivered at the delivery address 80. If the query result from step 262 is “NO”, then the method 200 proceeds directly to step 264, wherein the forklift 60 is remounted on the truck 40. If, however, the query result from step 262 is “YES”, then the method 200 returns, as shown in FIG. 5C, to step 260. According to the method 200, the customer or homeowner need not be home when the delivery occurs, and the homeowner is offered a monetary incentive for returning the bulk soil bag 20 after it has been emptied.

Following step 264 of the method 200, the driver 70 then queries, in step 266, whether there are more delivery addresses 80 in the ordered sequence that was provided (in step 256) to the driver 70 of the delivery truck 40. If the query result from step 266 is “NO”, then the method 200 proceeds, through the placeholder step 268, to step 270 which is represented in FIG. 5D. If, however, the query result from step 266 is “YES”, then the method 200 returns, as shown in FIG. 5C, to step 258, wherein the driver 70 proceeds to the next delivery address 80 and dismounts the forklift 60 from the truck 40.

In step 270 of the method, the system 15 electronically calculates the number of bulk soil bags 20 which were delivered on the delivery date by the driver 70 of each truck 40. The driver 70 is preferably offered an incentive for reaching a certain prey determined daily delivery target.

Following step 270, in step 272 of the method 200, the system 15 queries whether there are more bulk soil bags 20 to be delivered on delivery dates in the coming days. If the query result from step 272 is “NO”, then the system 15 proceeds directly to step 274. If, however, the query result from step 272 is “YES”, then the system 15 proceeds, through the placeholder step 246, to return to step 244 which is represented in FIG. 5B.

In step 274 of the method 200, the order entry subsystem 50 queries whether there are further orders to be received. If the query result from step 274 is “NO”, then the system 15 proceeds, through placeholder step 206, to return to step 204 (represented in FIG. 5A) wherein marketing using targeted media therein alternately referred to as promotional circulars) may be reinitiated. If the query result from step 274 is “YES”, then the method 200 proceeds, through the placeholder step 216, to return to step 214 which is represented in FIG. 5A.

In use of the system 15 and methods 100, 200, generally in the manner which is described hereinabove with reference to the methods 100, 200, homeowners and amateur and professional horticulturalists and agriculturalists may facilitate the transfer of large (i.e., agriculturally and horticulturally effective) quantities of rich planting soil into their gardens and yards. Notably, the use of the system 15 and methods 100, 200 may facilitate such transfer to one or more locations on their property laying either substantially adjacent to, or substantially removed from, access by roads 30. It may be additionally appreciated by persons of ordinary skill in the art that such use may substantially protect the bulk soil from the elements and substantially prevent large portions of the soil from washing away, all without creating a substantial mess at the customer-specified location 82. Also, the use of the system 15 and methods 100, 200 according to the invention does not require soil purchasers to lift and transport, or otherwise make their own arrangements for delivery, to the customer-specified location 82. Of course, one of the chief advantages of the use of the system 15 and methods 100, 200 as described above may be the facility to precisely place the soil in a wide range of locations to suit the needs and/or preferences of consumers. Additionally, the use of the system 15 and methods 100, 200 may inventively offset, reduce, and/or mitigate the typically great monetary expense that would otherwise be associated with purchasing and maintaining trucks 40 having truck-mountable forklifts 60, thus making their use in the delivery of bulk soil more practical, cost effective and/or commercially viable. In view of the aforementioned advantages that are associated with the use of the system 15 and methods 100, 200, the present invention obviates and/or mitigates one or more of the above-mentioned disadvantages, shortcomings, and/or problems associated with the prior art.

It is specifically noted at this point that, while each of the first and second preferred embodiments of the system, 100 and 200 respectively, which are disclosed above includes marketing, order entry and delivery phases, the invention is not so limited. In fact, the invention contemplates that one or more of these phases may instead be used on its own, without the other ones.

Other modifications and alterations may be used in the design, manufacture, or carrying out of other embodiments according to the present invention without departing from the spirit and scope of the invention, which is limited only by the accompanying claims. For example, the system is disclosed for use in association with soil and sod, but certain aspects thereof might be used on their own, and/or in combination with other aspects hereof, with other products, including bulk products generally and otherwise.

We claim:

1. A method of bulk soil order entry, delivery and marketing, said method comprising the steps of:
a) receiving and electronically recording an order for delivery of one or more substantially agriculturally effective quantities of bulk soil; and electronically recording a delivery address for each said order, with said delivery address being in a geographic neighborhood;
b) mechanically loading said quantities of bulk soil into one or more bags, with each of said bags having a flexible bag body that contains one of said quantities of bulk soil, with said bag body defining a selectively closable bag aperture substantially adjacent to a top portion thereof, and with said bag body including an outer surface that has one or more promotional indicia marked thereon;
c) mechanically loading said bags onto a truck bed of a truck;
d) transporting said truck substantially to said delivery address; and
e) mechanically removing said bags from said truck bed, and precisely placing said bags substantially at a customer-specified location at said delivery address;
wherein each of said bags is positioned such that said promotional indicia are outwardly displayed, in substantially unobstructed relation, from at least one of said truck bed and said customer-specified location.

2. A method according to claim 1, wherein each of said bags is positioned such that said promotional indicia are outwardly displayed, in substantially unobstructed relation, from said customer-specified location.

3. A method according to claim 1, further comprising the steps, after step (e), of:
f) electronically generating target addresses from a database comprising prospective customer addresses, with each of said target addresses being substantially within said geographic neighborhood of said delivery address; and
g) marking said target addresses one each on promotional circulars, so as to provide for subsequent distribution of said promotional circulars to said target addresses.

4. A method according to claim 3, wherein said target addresses comprise substantially all of said prospective customer addresses within at least one zoned postal area.

5. A method according to claim 4, wherein said zoned postal area defines a region that is selected from the group consisting of a zip code area and a postal code area.

6. A method according to claim 3, wherein said promotional circulars display one or more order incentives that are redeemable prior to an incentive expiry date.

7. A method according to claim 1, further comprising the step, before step (a), of pre-scheduling said truck to make bulk soil deliveries in said geographic neighborhood on one or more delivery dates; and further comprising the step, before step (b), of electronically generating a prompt for customer selection of one of said delivery dates for said order.

8. A method according to claim 7, further comprising the step, before step (b), of electronically confirming, by comparison of said quantities with substantially current availability data for said truck and said bulk soil, that said quantities of bulk soil are available to be delivered within said geographic neighbourhood on said one of said delivery dates.

9. A method according to claim 8, further comprises the step, before step (b) in the event that said quantities are not available to be delivered within said geographic area on said one of said delivery dates, of electronically generating a second prompt for customer selection of another of said delivery dates for said order.

10. A method according to claim 7, further comprising the steps, before step (d), of:
c.1) grouping together each said delivery address within said geographic neighborhood;
c.2) sequencing in a substantially efficient delivery route each said delivery address that is to be visited by said truck on said one of said delivery dates; and
c.3) generating for sequential display within said truck one or more individual maps, with each one of said individual maps depicting one said delivery address.

11. A method according to claim 1, further comprising the step, before step (d), of electronically generating a reminder to have said customer-specified location physically marked at said delivery address.

12. A method according to claim 11, wherein each of said promotional circulars and said reminder is sent to said delivery address by at least one delivery methodology that is selected from the group consisting of mail delivery, facsimile delivery, courier delivery, delivery via the internet, and aural delivery via the telephone.

13. A method according to claim 1, wherein each of said bags is provided with one or more carry straps extending from said bag body, with said carry straps adapted to provide for substantially secure suspension therefrom of said bag body containing said one of said quantities of bulk soil; wherein before step (d), a forklift is mounted on said truck, and after step (d), said forklift is dismounted from said truck; and wherein in step (e), said forklift lifts each of said bags from said truck bed by said carry straps, and precisely places said bags substantially at said customer-specified, location.

14. A method according to claim 1, further comprising the steps, before completion of step (a), of electronically entering at least two approximate dimensions of a space for desired application of said bulk soil; and electronically calculating, using said dimensions, a minimum number of said bags required for said desired application.

15. A system for use in delivering bulk soil to a customer-specified location at a delivery address, said system comprising:
a) a plurality of bags, each having:
i) a flexible bag body that contains a substantially agriculturally effective quantity of bulk soil, with said bag body defining a selectively closable bag aperture substantially adjacent to a top portion thereof, and with said bag body including an outer surface that has one or more promotional indicia marked thereon; and
ii) one or more carry straps extending from said bag body, with said carry straps adapted to provide for substantially secure suspension therefrom of said bag body containing said quantity of bulk soil;
b) a truck having a truck bed, with said plurality of bags being supported on said truck bed, and with said truck being mobile to provide for transport to the delivery address; and
c) a forklift mounted on said truck during said transport to the delivery address, with said forklift being removable from said truck into a dismounted configuration at the delivery address and having forklift tines that are adapted to operatively lift at least one of said bags by said carry straps from said truck bed, and with said forklift being substantially mobile in said dismounted configuration to provide for precise placement of said at least one of said bags substantially at the customer-specified location;
wherein each of said bags is positioned such that said promotional indica are outwardly displayed, in substantially unobstructed relation, from at least one of said truck bed and the customer-specified location.

16. A system according to claim 15, wherein each of said bags is positioned such that said promotional indicia are outwardly displayed, in substantially unobstructed relation, from the customer-specified location.

17. A system according to claim 15, further comprising an order entry subsystem that electronically receives and records an order for delivery of said at least one of said bags, along with the delivery address.

18. A system according to claim 17, wherein said order entry subsystem electronically generates one or more sets of delivery instructions for display within said truck.

19. A system according to claim 17, wherein said order entry subsystem electronically generates a reminder to have the customer-specified location marked with an identifying indicia before said transport to the delivery address.

20. A system according to claim 17, wherein said order entry subsystem records the customer-specified location.

21. A system according to claim 15, wherein said bag body is adapted to substantially protect said quantity of bulk soil from external environmental conditions.

22. A system according to claim 15, wherein said bag body further comprises a cinchable strap means, substantially encircling said top portion of said bag body, for selectively closing said bag aperture.
